(19) United States
(12) Patent Application Publication
(10) Pub. No.: US 2015/0278559 A1
(43) Pub. Date: Oct. 1, 2015

(54) CARD CONTACT-MAKING APPARATUS

(71) Applicant: AMPHENOL-TUCHEL ELECTRONICS GMBH, Heilbronn (DE)

(72) Inventors: Thomas Schnell, Heilbronn (DE); Cyril Damnon, Eppingen (DE)

(73) Assignee: Amphenol Tuchel Electronics GmbH, Heilbronn (DE)

(21) Appl. No.: 14/437,407

(22) PCT Filed: Sep. 27, 2013
(86) PCT No.: PCT/EP2013/002915

§ 371 Date: Apr. 21, 2015

(30) Foreign Application Priority Data
Nov. 7, 2012 (DE) 10 2012 021 672.6

(51) Int. Cl. G06K 7/00; H01R 12/62; H01R 4/48; H01R 43/16

(52) U.S. Cl. CPC G06K 7/0021; H01R 43/16; H01R 12/62; H01R 4/48

(57) ABSTRACT

The invention relates to a card contact-making apparatus for a card, wherein the card contact-making apparatus has a flat contact carrier support with side edges and also has a flexible contact carrier, and wherein the contact carrier support forms several holding means which project through recesses in the contact carrier in order to mechanically connect the flexible contact carrier to the contact carrier support.

The present invention relates to a card contact-making apparatus as claimed in claim 1, and also to a method for producing a card contact-making apparatus as claimed in claim 18.

In the prior art, card-reading apparatuses which comprise a card contact-making apparatus for making contact with the corresponding card are used to make contact with cards such as SIM cards, memory cards, micro SD cards and other cards.

There is an increasing requirement to reduce the physical size, in particular the thickness, of the card contact-making apparatus.

Therefore, the prior art contains different measures for reducing the card thickness. By way of example, in the case of SIM card contact-making apparatuses which have a moving cover, the bearing points of the contact-making apparatus have, for example, been fitted to the side of the contact carrier such that a the inserted card is moved from a pre-assembly position to a final-assembly position by means of a control mechanism on the top face of the contact carrier. It was possible to reduce the thickness of a corresponding contact carrier in this way.

Further measures which are known in the prior art are, for example, the reduction of the material thicknesses used as such. Therefore, it is possible, for example, for the contact carrier, which has the reading contacts, to be reduced to a minimum height. One problem with this is that as the material thickness falls, the stability of the contact carrier is no longer adequate for use in the majority of applications. A further problem arises with the coplanarity of the reading contacts. The connection ends of the reading contacts in a contact carrier ideally have to lie in one plane, so that the process of soldering onto a printed circuit board can be implemented in a reliable manner.

This necessarily leads to problems in the case of unstable contact carriers.

One object of the present invention is therefore to provide a thin card contact-making apparatus which can make reliable contact with a card and has a minimum physical height.

A further object of the present invention is to provide a connecting method between a printed circuit board and the reading contacts of the card contact-making apparatus, which connecting method is reliable and can be reproduced.

The present object is achieved by a card contact-making apparatus as claimed in claim 1, and also by a method for producing a card contact-making apparatus according to the invention as claimed in claim 18.

Further particular embodiments of the contact-making apparatus according to the invention can be found in the dependent claims and also in the following drawings and the description of the exemplary embodiments.

A further object of the present invention is to provide a card contact-making apparatus with a push-push mechanism, so that a card can be inserted into the card contact-making apparatus by means of a first push and can be ejected from the card contact-making apparatus again by means of a second push (pressure on the card).

The basic idea of the present invention is that of providing a card contact-making apparatus for a card, wherein the card contact-making apparatus has a preferably flat contact carrier support, preferably formed from a metal, and also has a flexible contact carrier, and wherein the contact carrier support forms a plurality of holding means which protrude through recesses in the contact carrier, in order to mechanically connect the flexible contact carrier to the contact carrier support.

An embodiment of this kind allows a conventional contact carrier to be dispensed with and, in addition, conventional spring arms are no longer required as reading contacts, and instead the flexible contact carrier provides both the conductor tracks and also the reading contacts.

A plurality of contact points which can make direct contact with the contact pads of a card are preferably formed on the surface of the flexible contact carrier in a contact-making region.

Furthermore, the contact-making apparatus according to the invention has a contact carrier support which mechanically holds the flexible contact carrier. To this end, the contact carrier support provides holding means, preferably hook-like holding means, which have a holding section and a fastening section. The fastening section connects the holding section to the contact carrier support and it is possible to bend the holding means around the fastening section by way of its holding section.

Since, according to the invention, the flexible contact carrier has corresponding recesses, specifically recesses in the contact carrier, through which the preferably hook-like holding means can be threaded and can then be bent over, a mechanical connection between the flexible contact carrier and the contact carrier support can be achieved in a predefined position.

In this respect, a card contact-making apparatus is provided which has holding means in the form of hook-like holding means having a holding section and a fastening section, wherein the holding means are connected to the contact carrier support, and said holding means can be moved from a pre-assembly position to a final-assembly position by being bent over.

The holding sections of the card contact-making apparatus advantageously protrude away from one side face or from both side faces of the contact carrier support in the pre-assembly position, and are bent over parallel to the corresponding side faces, so as to form a gap, in the final-assembly position. If the gap width corresponds approximately to the thickness of the flexible contact carrier, can be accommodated between the fastening section and the side face of the contact carrier support.

In a preferred embodiment, the flexible contact carrier is designed with a fastening section at an end and the fastening section at an end is folded over around a side edge of the contact carrier support.

This provides two advantages. Firstly, a particularly good mechanical connection between the contact carrier support and the flexible contact carrier can be achieved as a result, and furthermore the advantage is provided of production of a card contact-making apparatus of this kind being able to be defined with respect to position over a side edge of the contact carrier support in a reproducible manner. Since the contact carrier support is advantageously in the form of a stamped metal part, particularly accurate definition of side edges and position of the holding means which are arranged at a distance therefrom can be defined. Therefore, a high degree of manufacturing accuracy is achieved for the production process.

The flexible contact carrier preferably has a contact-making section with a plurality of contact points for making contact with the card. Furthermore, the fastening section at an end has at least one recess, preferably a plurality of recesses which are arranged next to one another, for at least one or more of the holding means.

Furthermore, a second fastening section having at least one or more further recesses for at least one or more further holding means is advantageously provided on the flexible contact carrier. Said further holding means are advantageously arranged on the opposite side face of the contact carrier support.

In a particularly preferred embodiment, the contact-making section is situated between the fastening section at an end and the second fastening section. As a result, the contact-making section can be reliably positioned, and the adjacent fastening sections ensure and the fastening sections which are respectively adjacent thereto ensure that the flexible contact carrier is held particularly well.

The hook-like holding sections, in their bent-over state, preferably extend from the side edge of the contact carrier support through the recesses in one direction, specifically preferably perpendicular to the side edge in the direction of the opposite side edge.

Furthermore, the contact carrier support preferably has a plurality of spring arms with spring domes. In this case, the spring arms protrude at least partially out of a side face of the contact carrier support by way of their spring domes.

The spring domes advantageously protrude on that side face of the contact carrier support which is situated opposite the side face which has the holding means for the fastening section of the flexible contact carrier.

The spring domes are advantageously preferably directly arranged on the rear face of the flexible contact carrier in a manner corresponding to the position of the contact points of said flexible contact carrier. As a result, the spring domes which protrude out of the side face of the contact carrier support press, as it were, onto the flexible contact carrier from the rear, so that the contact points of the contact carrier act like spring contacts.

If a card, by way of its contact areas, is pressed onto the card contact-making apparatus, specifically onto the contact-making section, the contacts make contact with the contacts of the card with a spring action, in which the spring arms, by way of their spring domes, press onto the flexible printed circuit board from the rear with a spring action.

Furthermore, the flexible contact carrier advantageously has a plurality of conductor tracks. The conductor tracks serve firstly for contact to be made by a superordinate component, such as a main printed circuit in a mobile telephone or in a mobile terminal for example, and secondly for making contact with the contact points or switching elements which are arranged in the flexible contact carrier.

In a particularly advantageous embodiment, the flexible contact carrier has a flat plug connection in order to be able to be plugged directly into a corresponding plug receptacle of another component.

Furthermore, a card contact-making apparatus with a push-push mechanism, that is to say with an operator which can be moved in and out, for inserting and ejecting a card is provided according to the invention.

The operator which can be moved in and out advantageously has a card stop which extends at least partially into a region above the flexible contact carrier.

A nano SIM push-push card reader is provided in a particularly advantageous embodiment.

A method for producing a card contact-making apparatus for a card is also proposed, said method comprising the following steps:
a) providing a flat contact carrier support having side edges, wherein the contact carrier support has a plurality of holding moans, preferably a plurality of holding means which extend from side faces of the contact carrier support;
b) providing a flexible contact carrier which has a first and a second fastening section and each is provided with recesses in the contact carrier;
c) suspending the flexible contact carrier, by way of its recesses in its first fastening section, in the holding means of the contact carrier support;
d) bending over the holding means for fastening the flexible contact carrier;
e) folding over the flexible contact carrier around a side edge of the contact carrier support until said side edge rests on a side face of the contact carrier support;
f) suspending the flexible contact carrier, by way of the recesses in its second fastening section, from the holding means or from the further holding means of the contact carrier support; and
g) bending over the further holding means for fastening the second fastening section.

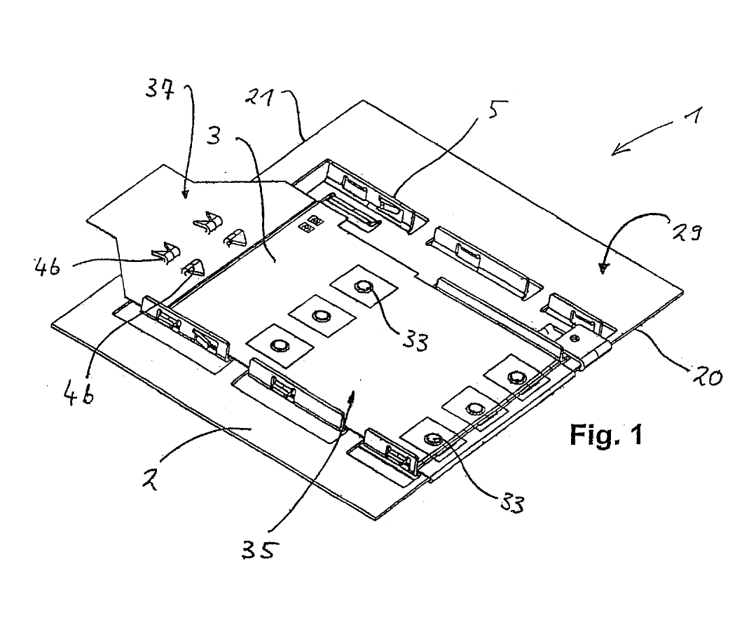

The invention will be explained in greater detail below with reference to FIGS. 1 to 8. In the figures:

FIG. 1 shows a perspective view of a first exemplary embodiment of a card contact-making apparatus according to the invention;

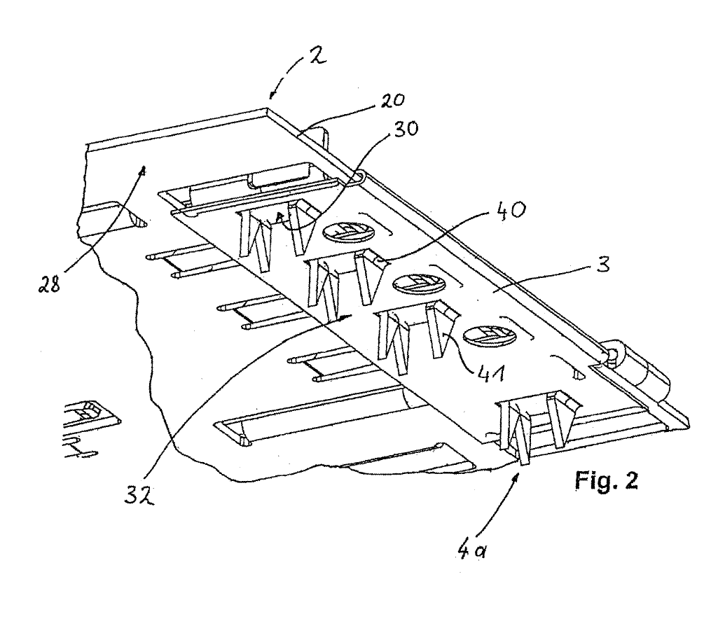

FIG. 2 shows a perspective view of a detail from FIG. 1;

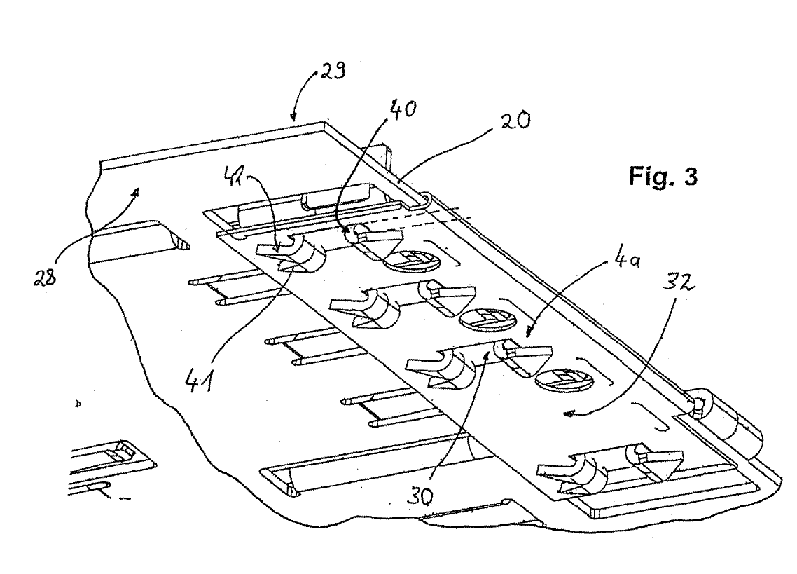

FIG. 3 shows a view of a detail, which is similar to FIG. 2, of a card contact-making apparatus according to the invention, in which holding means the flexible contact carrier;

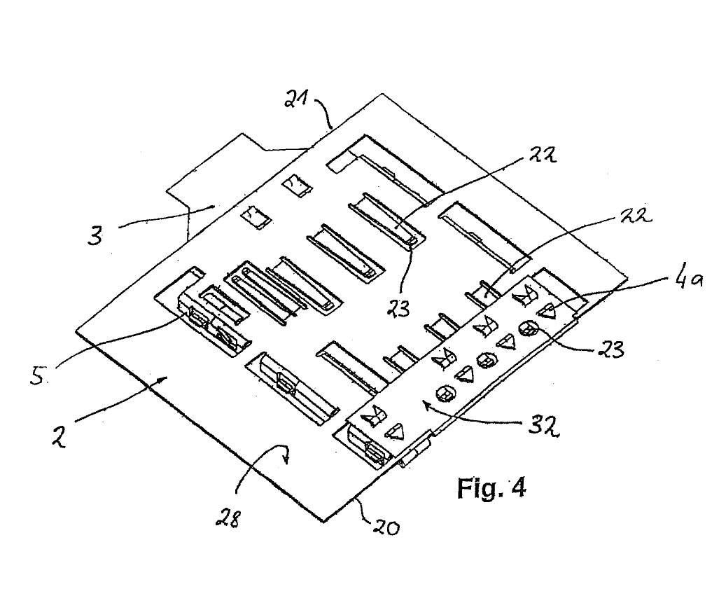

FIG. 4 shows a perspective view of a card contact-making apparatus according to the invention from FIG. 1 from below;

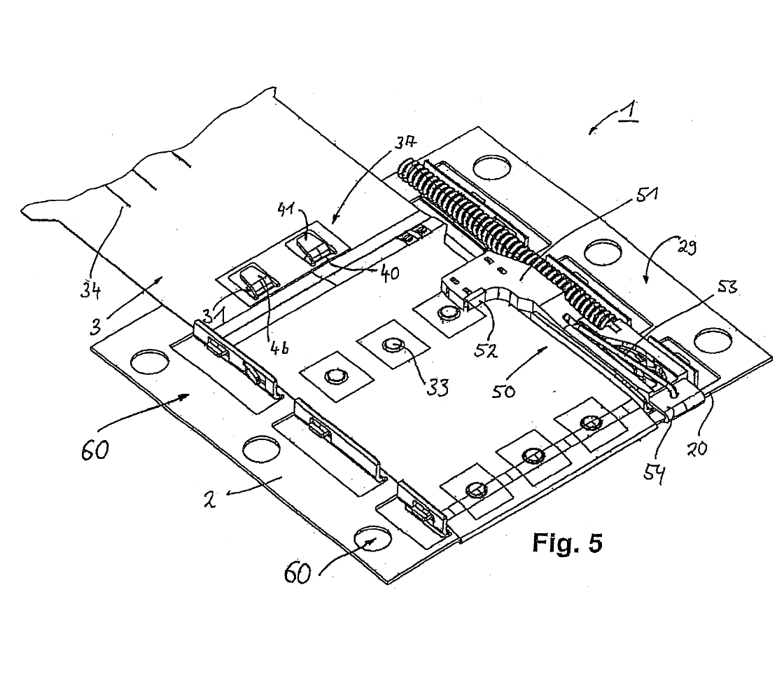

FIG. 5 shows a card contact-making apparatus according to the invention having a push-push mechanism;

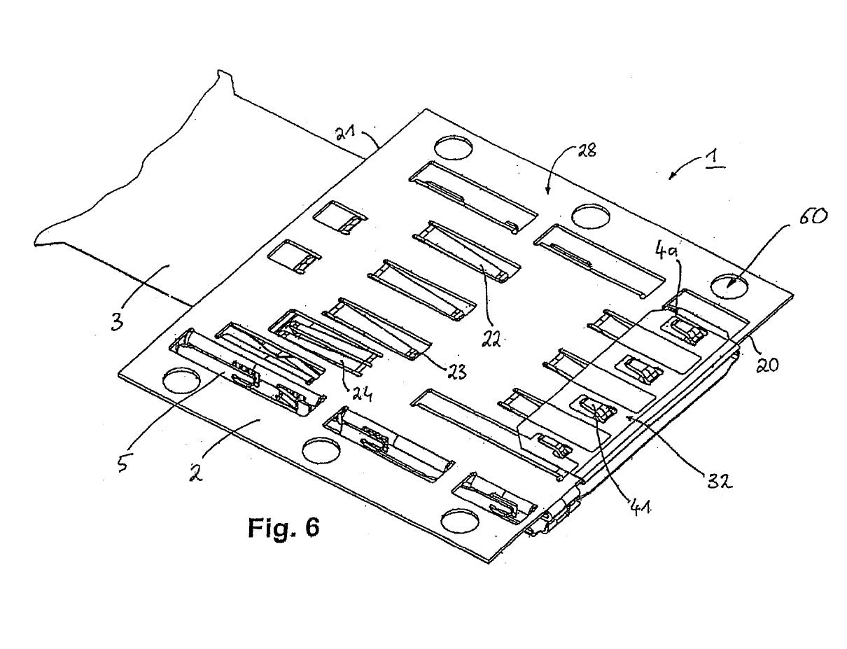

FIG. 6 shows a perspective view of the card contact-making apparatus according to FIG. 5 from below;

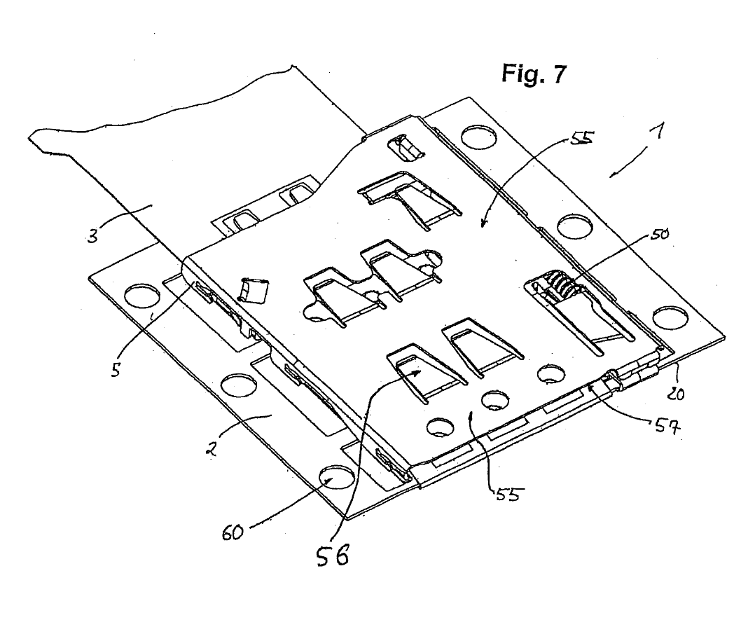

FIG. 7 shows a view, which is similar to FIG. 5, with a cover; and

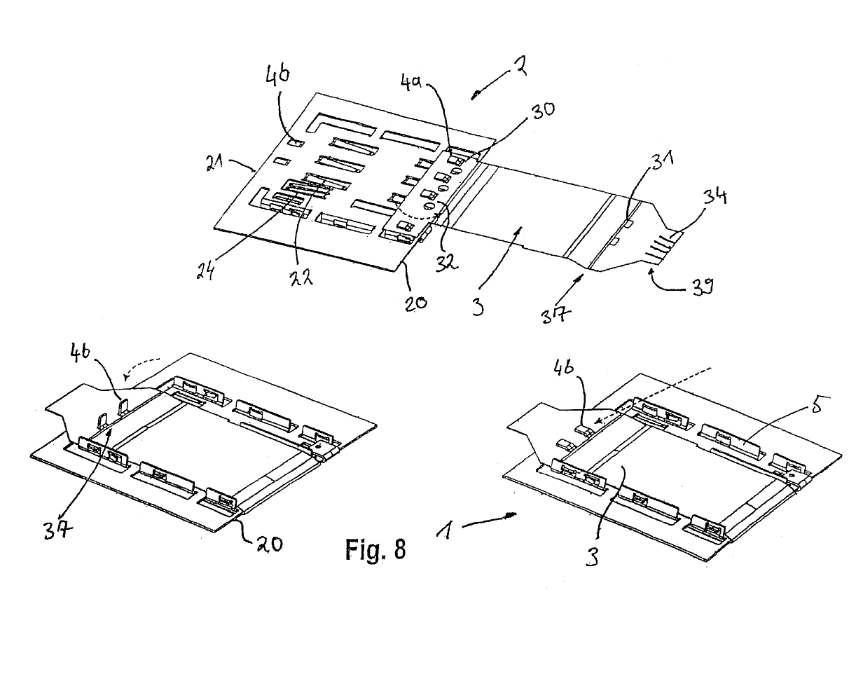

FIG. 8 shows three of the method steps for producing the card contact-making apparatus according to the invention.

FIG. 1 shows a perspective view of a first exemplary embodiment of a card contact-making apparatus 1 according to the invention. The card contact-making apparatus 1 comprises a contact carrier 2 which, as depicted here, has been produced as a stamped and bent part from a conventional sheet. According to the invention, a metal sheet is used. The contact carrier support 2 has holding means 4a, 4b. The holding means 4a are clearly shown in FIG. 2 and in FIG. 3.

FIG. 1 further shows that the card contact-making apparatus 1 according to the invention has a flexible contact carrier 3. Within the meaning of the present invention, a flexible contact carrier means a contact carrier 3 which can be bent, reshaped and bent back again. Therefore, it is necessary in any event for the flexible contact carrier 3 to be able to be folded over around a side edge 20 of the card contact-making apparatus 1, as shown in FIG. 1 to FIG. 3. The flexible contact carrier 3 has six contact points 33 on its surface here. The contact points 33 are arranged in accordance with the contact-making grid of the corresponding card 100. The contact carrier support 2 further has card stops 5 on the right-hand side and left-hand side. The contact carrier support 2 further has a side edge 20 and a side edge 21 which is situated opposite the side edge 20 (transversely running side edges 20, 21).

The side face, illustrated in FIG. 1, of the contact carrier support 2 is designated side face 29 and represents the top face of the contact carrier support 2. The bottom face, which is situated opposite the side face 29, constitutes the side face 28, as is shown in FIG. 2 and in FIG. 3. The holding means 4a are located on the side face 28, while holding means 4b are provided on the side face 29.

As shown in FIG. 2, the holding means 4a protrude through recesses 30 in the contact carrier, and are in a pre-assembly position here. By bending over the holding sections 41 around the fastening sections 40 with which the holding means 4a are fastened to the contact carrier support 2, the holding means 4a are moved into the position shown in FIG. 3. In this case, the flexible contact carrier 3 is clamped in and held between an inner face of the holding section 41 and the side face 28 of the contact carrier support 2.

As shown in FIG. 3, a right-hand side and a left-hand side holding means 4a are advantageously provided, so that the flexible contact carrier 3, by way of its recess 30, bears against one side edge of the recess 30 and against the opposite side edge of the recess 30, so that displacement in a longitudinal and transverse direction is precluded. Furthermore, side edges 42 of the holding means 4a form a lateral stop for the recesses 30, so that movement in the transverse direction, that is to say parallel to the side edge 20, is prevented. The flexible contact carrier 3 is securely fastened to the contact carrier support 2 in this way.

A plurality of holding means 4a which are spaced apart from one another and are arranged next to one another are advantageously arranged on the contact carrier support 2 at a distance from the side edge 20 in order to fasten the fastening section 32 at an end of the flexible contact carrier 3 to said contact carrier support.

As is further clearly shown in FIG. 3, the ends of the holding sections 41 are designed with points which can advantageously be crimped into the surface of the flexible contact carrier 3.

In other words, bending over the holding sections 41 in a suitable manner may result in a toothing effect with the flexible contact carrier 3 in which the pointed ends of the holding sections 41 at least partially enter the flexible contact carrier 3, provided that said holding sections are in their final-assembly position and run substantially parallel to the side face 28 or to the side face 29.

FIG. 4 shows a perspective view of the side face 28 of the card contact-making apparatus 1 from below. The fastening section 32, specifically the fastening section 32 at an end of the flexible contact carrier 3, is folded around the transversely running side edge 20 and fastened to the holding means 4a. Furthermore, spring arms 22 are formed on the contact carrier support 2. The spring arms 22 protrude, by way of their spring domes 23, at least partially from the side face 29. The spring domes 23 are arranged so as to correspond to the position of the contact areas, with which contact is to be made, of a card 100.

Furthermore, spring arms 24 which likewise have spring domes 23 and project slightly from the side face 29, that is to say from the surface of the contact carrier support 2, are provided. Switching contacts of a flexible contact carrier 3 are located here, said switching contacts being acted on by a spring force by the spring arms 24 when a card 100 is inserted into the card contact-making apparatus 1.

FIG. 5 shows an exemplary embodiment of a push-push card contact-making apparatus 1 according to the invention. This card contact-making apparatus 1 has a push-push mechanism 50.

The push-push mechanism 50 serves for inserting and ejecting a card 100, the card being inserted into the card contact-making apparatus 1 by means of a first push on a card 100, specifically into its read position, and the card being moved from its read position to its eject position by means of a second push on the card 100. The push-push mechanism 50 therefore has an operator 51 which can be moved in and out. The operator 51 further has a control bar 53. Here, the control bar 53 is illustrated as an elongate wire with two bent-over wire ends. Furthermore, a holding lug 54 is provided on the contact carrier support 2, said holding lug having a recess into which one end of the control bar 53 engages. The other end of the control bar 53 serves for control in a so-called cardioid cam which is likewise provided by the push-push mechanism 50.

Furthermore, a card stop 52 is shown on the operator 51, said card stop extending at least partially above the flexible contact carrier 3 and, when the operator 51 is operated, moving in and out at least partially above the flexible contact carrier 3.

FIG. 6 illustrates the card contact-making apparatus 1 according to the invention in line with FIG. 5 from below.

In this exemplary embodiment too, a flexible contact carrier 3 is folded over around the transversely running side edge by way of its fastening section 32 at an end, and is held by the holding means 4a which, here, are already bent over in their final-mounting position, specifically their bent-over position.

The second fastening section 37 has two recesses 31 through which the holding means 4b are routed, as is shown in FIG. 5. Conductor tracks 34 which, however, run within the flexible contact carrier 3 are also indicated in FIG. 5.

As is further clear from FIG. 6, the contact carrier support 2 likewise has spring arms 22 having spring domes 23. Furthermore, spring arms 24 are provided, which spring arms, like the spring arms 22, project from the surface, that is to say the side face 29, of the contact carrier support 2 by way of their spring domes 23.

In the present exemplary embodiment, the contact carrier support 2 is likewise produced as a stamped grid from a metal sheet. A material which provides the required spring properties for forming the spring arms 22, 24 is a suitable metal material. The contact carrier support 2 further provides a plurality of bent-over card stops 5 which have cover latching means.

FIG. 7 shows a similar view of the card contact-making apparatus 1 to that in FIG. 5, furthermore in which a cover 55 is connected and latched to the cover latching means of the card stops 5. The cover 55 provides a plurality of cover springs 56 which protrude into the card receiving space. A card insertion slot 57 for inserting a card 100 into the card contact-making apparatus 1 runs above the side edge 20.

FIG. 8 shows, in the top view, the provision of a flat contact carrier support 2 having side edges 20, 21, specifically transversely running side edges, wherein the contact carrier support 2 has a plurality of holding means 4a, 4b.

The same view further shows how a flexible contact carrier 3 is provided, said flexible contact carrier having above a first fastening section 32, specifically a fastening section 32 at an end, and a second fastening section 37 which is at a distance from said first fastening section, and wherein the the fastening sections 32, 37 are each provided with recesses 30, 31.

In a first assembly step, the flexible contact carrier 3 is suspended, by way of its first recesses 30 or by way of the recesses 30 in its first fastening section 32 at an end, in the holding means 4a; in this case, the holding means 4a can selectively already be bent over or project from the side face 28 of the contact carrier support 2 and be bent over into the bent-over position illustrated by the top view in FIG. 8.

In a further method step, the flexible contact carrier 3 is bent around the side edge 20, as is shown in the left-hand, bottom view from FIG. 8, and is routed through the holding means 4b by way of its recesses 31 into its fastening section 37. In this case, the flexible contact carrier 3 is folded over around the side edge 20 such that the flexible contact carrier 3 is folded over such that it bears by way of its side face against the side face of the contact carrier support 2. In this position, the second holding means 4b protrude through the recess 31 in the second fastening section 37.

In a further method step, the holding means 4b are bent over into a position as is shown in the bottom, right-hand view from FIG. 8. The card contact-making apparatus 1 produced in this way can further be provided with a cover 55, which is preferably fastened to card stop means 5 of the contact carrier support 2, so as to form a card receiving space.

Only the contact points 33 are not illustrated in FIG. 8. However, the flexible contact carrier 3 has corresponding contact points 33.

Furthermore, the spring arms 22 can be formed in the contact carrier support 2, preferably by stamping and bending, in a further method step.

Furthermore, the spring arms 22 can preferably be designed with spring domes 23 by reshaping the ends of the spring arms 22, 24 with to form spring domes 23.

### LIST OF REFERENCE SYMBOLS

### Card Contact-Making Apparatus

1 Card contact-making apparatus
2 Contact carrier support
3 Flexible contact carrier
4a, 4b Holding means
5 Card stop (card stop means)
20, 21 Side edge
22 Spring arms
23 Spring domes
24 Spring arms
28, 29 Side face
30 Recess (first recess)
31 Recess (second recess)
32 Fastening section at an end
33 Contact points
34 Conductor tracks
35 Contact-making section
37 Fastening section (second fastening section)
39 Opening
40 Fastening section
41 Holding section
42 Side edges
50 Push-push mechanism
51 Operator
52 Card stop
53 Control bar
54 Holding lug
55 Cover
56 Cover spring
57 Card insertion slot
100 Card
D Gap width

1. A card contact-making apparatus for a card, wherein the card contact-making apparatus has a flat contact carrier support with side edges and also has a flexible contact carrier, and wherein the contact carrier support forms a plurality of holding means which protrude through recesses in the contact carrier, in order to mechanically connect the flexible contact carrier to the contact carrier support.

2. The card contact-making apparatus as claimed in claim 1, characterized in that the holding means, in the form of hook-like holding means, have a holding section and a fastening section by way of which fastening section the holding means are connected to the contact carrier support, and said holding means can be moved from a pre-assembly position to a final-assembly position by being bent over.

3. The card contact-making apparatus as claimed in claim 2, characterized in that the holding sections protrude away from a side face of the contact carrier support in the pre-assembly position, and run parallel to the side face, so as to form a gap with a gap width, in the final-assembly position.

4. The card contact-making apparatus as claimed in claim 3, characterized in that the gap width corresponds approximately to the thickness of the flexible contact carrier.

5. The card contact-making apparatus as claimed in claim 1, characterized in that the flexible contact carrier with a fastening section at an end is folded over around a side edge of the contact carrier support.

6. The card contact-making apparatus as claimed in claim 1, characterized in that the flexible contact carrier has a contact-making section with a plurality of contact points for making contact with a card.

7. The card contact-making apparatus as claimed in claim 6, characterized in that the fastening section has at least one recesses for at least one holding means.

8. The card contact-making apparatus as claimed in claim 7, characterized in that a second fastening section has at least one further recesses for at least one further holding means.

9. The card contact-making apparatus as claimed in claim 8, characterized in that a contact-making section with a plurality of contact points for making contact with a card is formed between the fastening section at an end and the second fastening section.

10. The card contact-making apparatus as claimed in claim 2, characterized in that the hook-like holding sections extend away from the side edge of the contact carrier support through the recesses, specifically preferably perpendicular to the side edge substantially in the direction of the opposite side edge.

11. The card contact-making apparatus as claimed in claim 1, characterized in that the contact carrier support forms a plurality of spring arms with spring domes, and the spring arms protrude at least partially out of the contact carrier support by way of their spring domes.

12. The card contact-making apparatus as claimed in claim 11, characterized in that the spring domes protrude on that side face of the contact carrier support which is situated opposite the side face which have the holding means for the fastening section.

13. The card contact-making apparatus as claimed in claim 1, characterized in that the spring domes are arranged on the rear face layer of the flexible contact carrier in a manner corresponding to the positions of the contact points of said flexible contact carrier.

14. The card contact-making apparatus as claimed in claim 11, characterized in that the flexible contact carrier has a plurality of conductor tracks.

15. The card contact-making apparatus as claimed in claim 1, characterized in that the card contact-making apparatus has a push-push mechanism with an operator which can be moved in and out for inserting and ejecting a card.

16. The card contact-making apparatus as claimed in claim 15, characterized in that the operator which can be moved in and out is provided with a card stop which extends at least partially into a region above the flexible contact carrier.

17. The card contact-making apparatus as claimed in claim 1, characterized in that the contact-making apparatus is a nano SIM push-push card reader.

18. A method for producing a card contact-making apparatus for a card, comprising the following steps:
a) providing a flat contact carrier support having side edges, and wherein the contact carrier support has a plurality of holding means;
b) providing a flexible contact carrier which has a first and a second fastening section and each is provided with recesses in the contact carrier;
c) suspending the flexible contact carrier, by way of the recesses in its first fastening section, in the holding means of the contact carrier support;
d) bending over the holding means;
e) folding over the flexible contact carrier around a side edge of the contact carrier support until said side edge rests on a side face of the contact carrier support;
f) suspending the flexible contact carrier, by way of the recesses in its second fastening section, from the holding means of the contact carrier support; and
g) bending over the holding means.
